(19) United States
(12) Patent Application Publication
(10) Pub. No.: US 2026/0361068 A1
(43) Pub. Date: Nov. 12, 2026

(54) POWER SUPPLY OUTPUT PROTECTION STRUCTURE

(71) Applicant: SEA SONIC ELECTRONICS CO., LTD., Taipei City (TW)

(72) Inventors: Meng-Wen PAN, Taipei City (TW); Hung-Wei YANG, Taipei City (TW); Sheng-Chien CHOU, Taipei City (TW); Che-Chia HSU, Taipei City (TW); Chun-Wei LEE, Taipei City (TW)

(21) Appl. No.: 19/677,628

(22) Filed: May 14, 2026

Related U.S. Application Data
(63) Continuation-in-part of application No. 19/204,749, filed on May 12, 2025.

(51) Int. Cl. H02H 3/08

(52) U.S. Cl. CPC H02H 3/08

(57) ABSTRACT

A power supply output protection structure, including a power output port, a wireless communication module, and a work management circuit. The power output port includes a plurality of power supply pins and a plurality of signal pins, wherein the power supply pins are connected in parallel for power output. The work management circuit is connected to at least one of the power supply pins and the signal pins. The work management circuit separately performs current detection on each of the power supply pins and protects the power output port according to a detection result of each of the power supply pins. The work management circuit is connected to the wireless communication module and, through the wireless communication module, transmits an output port status information to a system side having completed handshaking with the wireless communication module.

### TECHNICAL FIELD

The present invention relates to a power supply output protection structure, in particular to a structure that provides output protection for an electrical output port on a power supply.

### BACKGROUND ART

Increased CPU and GPU computing performance requires more power to support computing. In the case of GPUs, high-end GPUs require 600~1800 watts to operate. To meet the demand for high power output, today's power supplies are equipped with power output ports that specialize in high power output. The power output ports contain a plurality of power supply pins that are connected in parallel.

Although the power supply pins adopt parallel output, but due to the change of output power, power output port material, structure and other factors, resulting in these power supply pins in the current can not be evenly distributed, the power supply which pins to withstand more current is easy to overheat, a long period of time power supply is prone to make the power output port melting, or in serious cases will lead to the fire of the power supply device, affecting the safety.

### SUMMARY OF THE INVENTION

The main object of the present invention is to solve the safety problem caused by the inability to evenly distribute an output current of a power output port to a plurality of power supply pins.

In order to achieve the above-mentioned object, the present invention provides a power supply output protection structure, including a power output port, a wireless communication module, and a work management circuit. The power output port includes a plurality of power supply pins and a plurality of signal pins, wherein the power supply pins are connected in parallel for power output. The work management circuit is connected to at least one of the power supply pins and the signal pins. The work management circuit separately performs current detection on each of the power supply pins, and the work management circuit protects the power output port according to a detection result of each of the power supply pins, thereby preventing overheating and burnout of the power output port. The work management circuit is connected to the wireless communication module. The work management circuit generates an output port status information according to a detection result of each of the power supply pins and, through the wireless communication module, transmits the output port status information to a system side having completed handshaking with the wireless communication module.

In one embodiment, the work management circuit is connected to at least one of the signal pins, and the work management circuit performs protection on the power output port by one of followings:
transmitting a load reduction request to a load via at least one of the signal pins; or
stopping the power output port from outputting power.

In one embodiment, the power supply output protection structure includes a status warning element exposed on a power supply housing, the status warning element generates at least one visual prompt sufficient to attract a user's attention based on a warning signal, and the work management circuit is connected to the status warning element. The work management circuit performs protection on the power output port, including:
outputting the warning signal to the status warning element.

In one embodiment, a condition for the status warning element to stop generating the visual prompt is that the work management circuit receives a reset signal provided by an external device.

In one embodiment, the external device is disposed on the power supply housing.

In one embodiment, the work management circuit transmits the output port status information to the system side through the wireless communication module based on a frequency, and, when an abnormal condition is satisfied, the work management circuit disregards the frequency and immediately transmits the output port status information to the system side through the wireless communication module.

In one embodiment, the output port status information transmitted by the work management circuit when the abnormal condition is satisfied includes the output port status data before and after the abnormal condition is satisfied.

In one embodiment, the work management circuit includes a memory unit, wherein the memory unit is controlled to store detection results, and the work management circuit performs early-warning protection based on historical detection results stored in the memory unit and current detection results.

In one embodiment, the work management circuit includes a temperature sensor positioned adjacent to an area where a temperature of the power output port can be detected, and the work management circuit incorporates a temperature signal generated by the temperature sensor into protection of the power output port.

In one embodiment, the work management circuit includes a plurality of detection circuits electrically connected to the power supply pins, a signal amplifier connected to the detection circuits, and a microcontroller connected to the signal amplifier.

In one embodiment, the power output port is disposed on an output circuit board of a power supply.

In one embodiment, the power output port includes a housing provided for the power supply pins to be arranged in a matrix.

In one embodiment, the power output port is a specification with a 12V and a 2X6 matrix.

The above-mentioned technical implementation of the present invention has the following characteristics compared to the conventional technology: the present invention performs current detection on each of the power supply pins individually through the work management circuit, and protects the power output port according to the detection result of each of the power supply pins, so as to prevent the power output port from overheating and burnout, thereby improving the safety of the power supply.

### BRIEF DESCRIPTION OF THE DRAWINGS

FIG. 1 is a schematic diagram of a unit of an embodiment of an output protection structure of a power supply of the present invention.

FIG. 2 is a schematic diagram of an appearance of a power supply according to an embodiment of an output protection structure of a power supply of the present invention.

FIG. 3 is a circuit diagram of an embodiment of an output protection structure of a power supply of the present invention.

FIG. 4 is a schematic diagram of a unit of another embodiment of an output protection structure of a power supply of the present invention.

FIG. 5 is a schematic diagram of an appearance of a power supply according to another embodiment of an output protection structure of a power supply of the present invention.

FIG. 6 is a schematic diagram of a unit of further embodiment of an output protection structure of a power supply of the present invention.

### DETAILED DESCRIPTION OF THE INVENTION

The terminology in the description of the various embodiments herein is used for the purpose of describing particular examples only. As used herein, the singular forms "a", "an" and "the" are intended to include the plural forms as well, unless the context clearly indicates otherwise or the number of elements is intentionally limited. It will be further understood that the term “comprising” when used herein indicates the presence of stated features, elements and/or components, but does not preclude the addition or presence of one or more other features, elements, components and/or groups thereof.

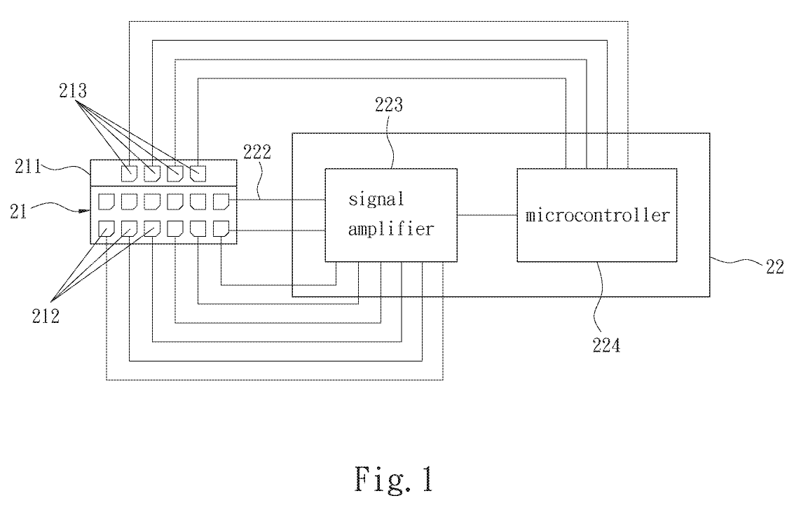

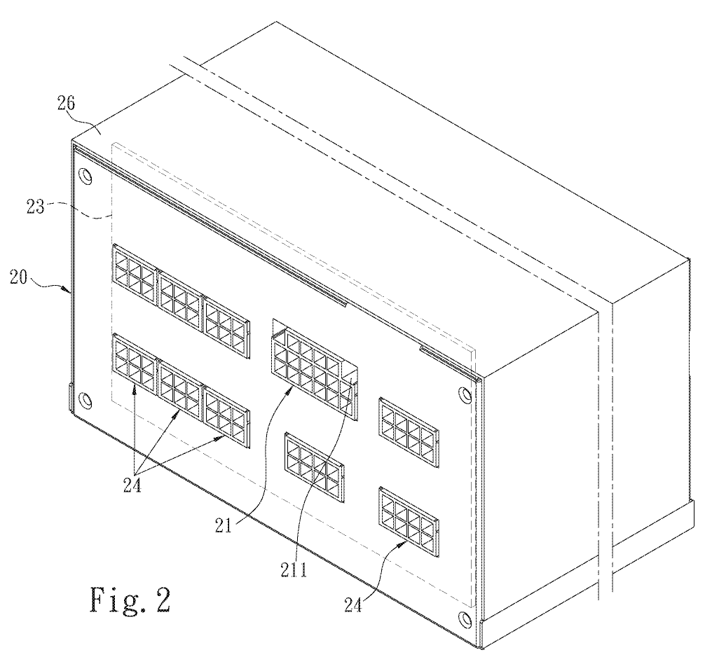

Referring to FIGS. 1, 2 and 3, the present invention provides a power supply output protection structure, which is applied to a power supply 20. The power supply 20 is designed based on ATX (Advanced Technology Extended) or/and its extended specifications. The power supply output protection structure includes a power output port 21 and a work management circuit 22.

In one embodiment, the power output port 21 is disposed on an output circuit board 23 of the power supply 20. In addition to the power output port 21, the output circuit board 23 is further provided with a plurality of connection ports 24. An output power of the connection ports 24 is set based on the ATX specification. The power output port 21 of the present invention is adapted for the selective insertion of a power transmission wire (not shown), and the power supply 20 provides power to a load connected to the power transmission wire through the power output port 21.

In one embodiment, the load is a display card, with a power requirement of the display card is 12 volts (V) 600~1800 watts. Therefore, the power output port 21 is a specification with a 12V and a 2X6 matrix. The power output port 21 includes a housing 211 and a plurality of power supply pins 212. The housing 211 is provided for the power supply pins 212 to be arranged in a matrix. The power supply pins 212 are connected in parallel for output. More specifically, a number of the power supply pins 212 is 12 and the power supply pins 212 are arranged in a 2X6 matrix. Two of the power supply pins 212 in the same row are respectively set as a 12V pin and a ground pin, and the power supply pins 212 in the same column have the same power supply setting. Although the power supply pins 212 are connected in parallel to supply power, the currents output by the power supply pins 212 may not be uniform, that is, at least one of the power supply pins 212 may bear a larger current. Under long-term power supply, the power supply pins 212 that bear more current have the risk of overheating and burning.

In addition to the foregoing, in one embodiment, the power output port 21 includes a plurality of signal pins 213 connected to the load via a plurality of signal wires. Signals on the signal pins 213 can indicate a current available power of the load.

On the other hand, the work management circuit 22 performs current detection on each of the power supply pins 212 separately, and the work management circuit 22 protects the power output port 21 according to a detection result of each of the power supply pins 212. For example, if a current value detected by at least one of the power supply pins 212 exceeds a threshold, the work management circuit 22 will perform protection to avoid the burning problem caused by continuous power supply. The aforementioned protection may be a warning or a method of reducing output of the power output port 21.

In one embodiment, the work management circuit 22 is connected to at least one of the signal pins 213. The work management circuit 22 protects the power output port 21 by one of followings:
transmitting a load reduction request to the load via at least one of the signal pins 213;
stopping the power output port 21 from outputting power.

As mentioned above, the aforementioned protection can form a multi-level protection. When the current value detected by at least one of the power supply pins 212 exceeds the threshold, the work management circuit 22 may first request the load to reduce its power consumption through at least one of the signal pins 213. During a load reduction process, the work management circuit 22 can be set to observe power supply conditions of the signal pins 213 whose detection results exceed the threshold for a period of time, and release a restriction only after it stabilizes.

The aforementioned load reduction is to define an available power of the load through a setting value of each of the signal pins 213, such as an upper limit of 600 watts or an upper limit of 900 watts. Furthermore, when the current value detected by at least one of the power supply pins 212 obviously exceeds the threshold value, the work management circuit 22 stops the power output port 21 from outputting power to protect the power output port 21.

Furthermore, the above two protection options are implemented in multiple levels. When the work management circuit 22 determines that the status is still within the controllable range, the load can reduce its power consumption. Once the status has reached a higher level of risk, the power output port 21 is stopped from outputting power. It should be understood that in order to avoid damage to the load caused by immediately stopping the output power, the work management circuit 22 does not stop the power supply immediately when executing the stop of the output power, but provides a buffer time so that the load can be closed buffered.

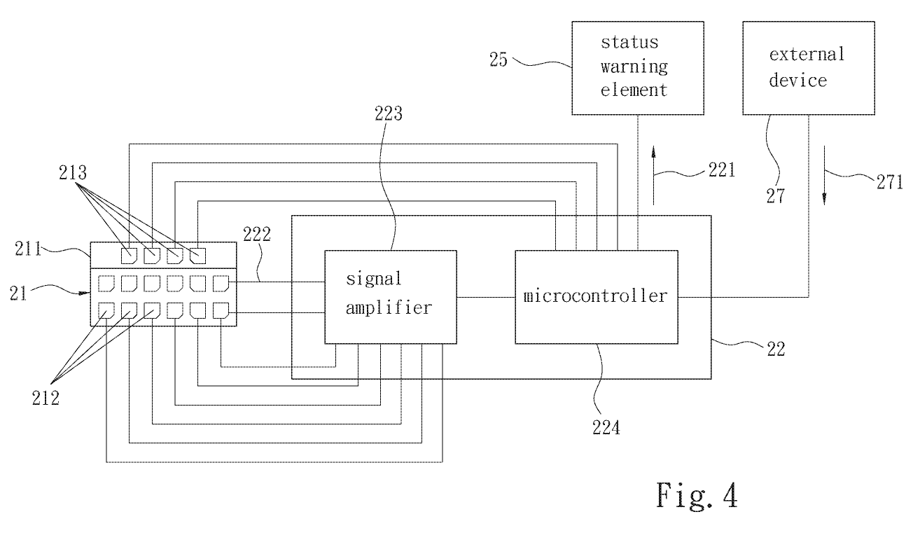

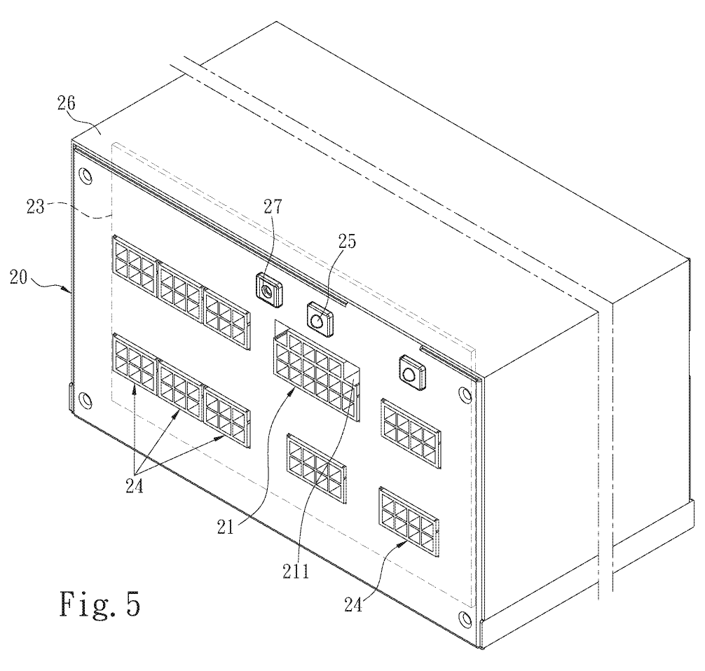

Referring to FIGS. 4 and 5, in addition to the above, in one embodiment, the power supply output protection structure includes a status warning element 25 exposed on a power supply housing 26. The status warning element 25 generates at least one visual prompt sufficient to attract a user's attention based on a warning signal 221, and the work management circuit 22 is connected to the status warning element 25. In this embodiment, the protection performed by the work management circuit 22 on the power output port 21 includes outputting the warning signal 221 to the status warning element 25.

As mentioned above, when the status warning element 25 is a light-emitting element, the at least one visual prompt may be a conspicuous light signal (such as a continuously flashing red light). When the status warning element 25 is a display, the at least one visual prompt can be a text prompt or an image prompt.

Furthermore, this embodiment can be implemented together with the previous embodiment, that is, the work management circuit 22 performing protection on the power output port 21 by one of followings:
outputting the warning signal 221 to the status warning element 25;
transmitting a load reduction request to the load via at least one of the signal pins 213;
stopping the power output port 21 from outputting power.

Further, the work management circuit 22 can be configured to simultaneously perform "outputting the warning signal 221" and "transmitting a load reduction request to the load", or to implement them sequentially based on a tiered protection level concept. In the tiered protection level concept, it is not limited to designate "outputting the warning signal 221" as a fundamental protection level. Instead, "transmitting the load reduction request to the load" may serve as the fundamental protection level, with the aforementioned "outputting the warning signal 221" considered as the next level of protection.

Referring to FIG. 4, in one embodiment where the power supply output protection structure includes the status warning element 25, a condition for the status warning element 25 to stop generating the visual prompt is that the work management circuit 22 receives a reset signal 271 provided by an external device 27. The external device 27 is capable of communicating with the work management circuit 22. In one embodiment, the external device 27 is disposed and exposed on the power supply housing 26 for user to operate to generate the reset signal 271. In addition to the above, the external device 27 may not be disposed on the power supply housing 26, but may communicate with the work management circuit 22 via wired or wireless.

Referring to FIGS. 1 and 4, in one embodiment, the work management circuit 22 includes a plurality of detection circuits 222 electrically connected to the power supply pins 212, a signal amplifier 223 connected to the detection circuits 222, and a microcontroller 224 connected to the signal amplifier 223. The microcontroller 224 has recorded a plurality of execution programs before implementation.

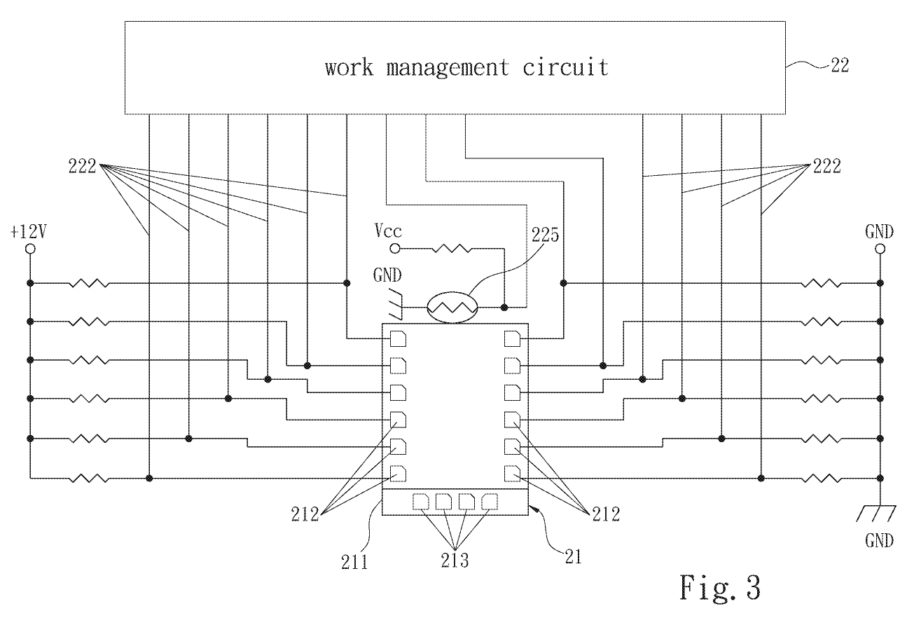

Referring to FIG. 3, in one embodiment, the work management circuit 22 further includes a temperature sensor 225 electrically connected to the microcontroller 224. The temperature sensor 225 is positioned near an area where a temperature of the power output port 21 can be detected. The term "near" may refer to being in direct contact with the housing 211 of the power output port 21, or being placed adjacent to the power output port 21 in a position that can clearly detect its temperature changes. In this embodiment, the work management circuit 22 may incorporate a sensing result of the temperature sensor 225 into a protection factor. When the temperature of the housing 211 of the power output port 21 rises significantly and meets a temperature rise protection condition defined in a program memorized by the microcontroller 224, the work management circuit 22 may protect the power output port 21 according to the aforementioned protection method.

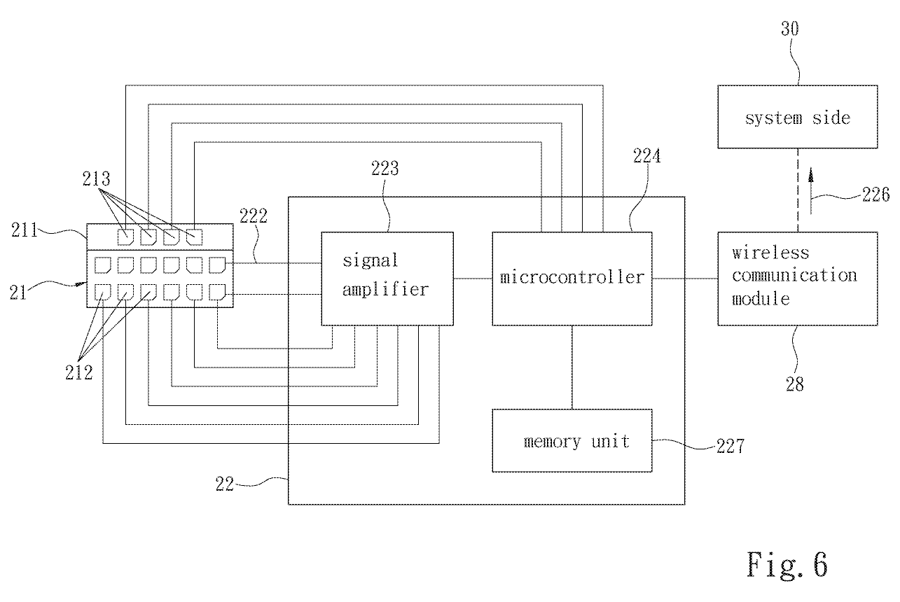

Referring to FIG. 6, the power supply output protection structure further includes a wireless communication module 28. The wireless communication module 28 is connected to the work management circuit 22. In one embodiment, the wireless communication module 28 is connected to the microcontroller 224 of the work management circuit 22. Power required for operating the wireless communication module 28 can be obtained from the work management circuit 22 or from other components of the power supply 20, such as a standby power supply module.

The wireless communication module 28 may respond to a handshake request issued by a system side 30, and, upon completion of handshaking, the system side 30 is regarded as a communication counterpart. The system side 30 refers to a computer system equipped with the power supply 20 or another electronic device having information processing capability. The aforementioned computer system may display related information on a graphical user interface (GUI) for operation. In one embodiment, the wireless communicaion module 28 is Bluetooth.

In implementation, the work management circuit 22 generates an output port status information 226 according to a detection result of each of the power supply pins 212. The output port status information 226 is not limited to highlighting a power supply status of each of the power supply pins 212, but may instead present information in a manner convenient for understanding, for example, by merely indicating an overall status of the power output port 21. The output port status information 226 may comprise the following information: current output data, whether a warning condition exists, and whether a protection state has been entered.

The work management circuit 22 transmits the output port status information 226, through the wireless communication module 28, to the system side 30 having completed handshaking with the wireless communication module 28. The system side 30 may perform corresponding control based on the output port status information 226, or display the output port status information 226 on the gaphical user interface.

In one embodiment, the work management circuit 22 transmits the output port status information 226 to the system side 30 through the wireless communication module 28 based on a frequency. The frequency may be set according to implementation requirements and may be every few seconds or every few minutes. Furthermore, when the power supply 20 is in a heavy-load output state, the frequency may be significantly higher than when the power supply 20 is in a light-load output state.

In one embodiment, the microcontroller 224 of the work management circuit 22 may be configured with the following procedure: when an abnormal condition is satisfied, the frequency is disregarded and the output port status information 226 is immediately transmitted to the system side 30 through the wireless communication module 28. The abnormal condition may be based on a numerical comparison result or a prediction result. Satisfaction of the abnormal condition may be a result of calculations performed by the microcontroller 224.

In one embodiment, the microcontroller 224 predicts a possibility of abnormality of status of the power output port 21 based on an operation procedure stored in its own memory or stored in a memory unit 227 comprised in the work management circuit 22. The microcontroller 224 may perform the prediction through a stored prediction model, wherein the prediction is based on temperature variation and/or current variation of status of the power output port 21. After computation by the microcontroller 224, when a variation of temperature and/or current, or an estimated output curve, satisfies a definition of abnormality in the operation procedure, the microcontroller 224 immediately transmits, through the wireless communication module 28, the output port status information 226 comprising abnormality information to the system side 30. Accordingly, in the present embodiment, the microcontroller 224 treats warning of abnormality or warning of potential abnormality as a highest priority level. Once the microcontroller 224 determines, through computation, that abnormality exists or is likely to occur, the microcontroller 224 disregards the frequency and immediately transmits the output port status information 226 to the system side 30 through the wireless communication module 28.

In one embodiment, when the abnormal condition is satisfied, the output port status information 226 transmitted by the work management circuit 22 through the wireless communication module 28 comprises the output port status data before and after satisfaction of the abnormal condition. After computation, the microcontroller 224 records and stores the output port status information 226 at each time point as historical records. The output port status data before satisfaction of the abnormal condition may refer to the last output port status information 226 transmitted by the work management circuit 22 to the system side 30 through the wireless communication module 28 before occurrence of the abnormality. The output port status data after satisfaction of the abnormal condition refers to the output port status information 226 at a time when the abnormality occurs. Accordingly, a user may understand conditions before and after the abnormality so as to discover cause of the problem.

Referring to the foregoing embodiment, the memory unit 227, under control of the microcontroller 224, stores the detection results (or the output port status information 226), and the microcontroller 224 causes the memory unit 227 to store the information record by record. The work management circuit 22 performs early-warning protection based on historical detection results stored in the memory unit 227 and current detection results. Specifically, when executing a preset abnormality operation procedure, the microcontroller 224 incorporates both the historical detection results and the current detection results into computation.

1. A power supply output protection structure, comprising:
a power output port, comprising a plurality of power supply pins and a plurality of signal pins, the power supply pins being connected in parallel for power output; and
a wireless communication module; and
a work management circuit, connected to at least one of the plurality of power supply pins and the plurality of signal pins, separately performing current detection on each of the plurality of power supply pins, and protecting the power output port according to a detection result of each of the plurality of power supply pins, thereby preventing the power output port from overheating and burnout, the work management circuit being connected to the wireless communication module, the work management circuit generating an output port status information according to a detection result of each of the power supply pins and, through the wireless communication module, transmitting the output port status information to a system side having completed handshaking with the wireless communication module.

2. The power supply output protection structure according to claim 1, wherein the work management circuit is connected to at least one of the plurality of signal pins, and the work management circuit protects the power output port by one of followings:
transmitting a load reduction request to a load via at least one of the signal pins; or
stopping the power output port from outputting power.

3. The power supply output protection structure according to claim 2, wherein the power supply output protection structure comprises a status warning element exposed on a power supply housing, the status warning element generates at least one visual prompt sufficient to attract a user's attention based on a warning signal, the work management circuit is connected to the status warning element, and the work management circuit performing protection on the power output port comprises:
outputting the warning signal to the status warning element.

4. The power supply output protection structure according to claim 3, wherein a condition for the status warning element to stop generating the visual prompt is that the work management circuit receives a reset signal provided by an external device.

5. The power supply output protection structure according to claim 4, wherein the external device is disposed on the power supply housing.

6. The power supply output protection structure according to claim 1, wherein the work management circuit transmits the output port status information to the system side through the wireless communication module based on a frequency, and, when an abnormal condition is satisfied, the work management circuit disregards the frequency and immediately transmits the output port status information to the system side through the wireless communication module.

7. The power supply output protection structure according to claim 6, wherein the output port status information transmitted by the work management circuit when the abnormal condition is satisfied comprises an output port status data before and after the abnormal condition is satisfied.

8. The power supply output protection structure according to claim 6, wherein the work management circuit comprises a memory unit, the memory unit is controlled to store detection results, and the work management circuit performs early-warning protection based on historical detection results stored in the memory unit and current detection results.

9. The power supply output protection structure according to claim 8, wherein the work management circuit comprises a temperature sensor positioned adjacent to an area where a temperature of the power output port can be detected, and the work management circuit incorporates a temperature signal generated by the temperature sensor into protection of the power output port.

10. The power supply output protection structure according to claim 9, wherein the work management circuit comprises a plurality of detection circuits electrically connected to the power supply pins, a signal amplifier connected to the detection circuits, and a microcontroller connected to the signal amplifier.

11. The power supply output protection structure according to claim 1, wherein the work management circuit comprises a plurality of detection circuits electrically connected to the plurality of power supply pins, a signal amplifier connected to the detection circuits, and a microcontroller connected to the signal amplifier.

12. The power supply output protection structure according to claim 11, wherein the power output port is disposed on an output circuit board of a power supply.

13. The power supply output protection structure according to claim 12, wherein the power output port comprises a housing provided for the plurality of power supply pins to be arranged in a matrix.

14. The power supply output protection structure according to claim 13, wherein the power output port is a specification with a 12V and a 2x6 matrix.
